(19) United States
(12) Patent Application Publication
(10) Pub. No.: US 2018/0321096 A1
(43) Pub. Date: Nov. 8, 2018

(54) EVALUATING PEDALING EFFICIENCY

(71) Applicant: Franklin J. DAY, Walnut Creek, CA (US)

(72) Inventor: Franklin J. DAY, Walnut Creek, CA (US)

(21) Appl. No.: 15/973,271

(22) Filed: May 7, 2018

Related U.S. Application Data
(60) Provisional application No. 62/503,207, filed on May 8, 2017.

(51) Int. Cl. G01L 3/26; B62M 1/36; B62M 3/16; G01L 5/26

(52) U.S. Cl. CPC G01L 3/26; B62M 1/36; B62K 2207/00; G01L 5/26; B62M 3/16

(57) ABSTRACT

A method and apparatus for measuring and evaluating pedaling efficiency of a cyclist. Instantaneous measurements of torque exerted through crank pedal arms are correlated with crank pedal arm positions through one or more complete crank rotations. Average torque exertion on the crank arms is determined for specific sectors of the entire crank rotation and the resulting values are compared. For example, the average torque through the top half of a crank rotation is compared with the average torque for an entire crank rotation, with a comparison expressed, for example, as a ratio. A numerical result of certain comparisons is thus obtained as guidance for future training of the cyclist to improve performance.

### BACKGROUND OF THE INVENTION

The present invention is related to training cyclists to pedal more efficiently and effectively.

The human body includes many muscles that are capable of contributing to moving a pedal of a bicycle or training device such as a stationary bike. There are four major muscle groups involved. They include the hip flexors which primarily move the foot up, the hip extensors which primarily move the foot down, the knee flexors which primarily move the foot backwards, and the knee extensors which primarily move the foot forward. It is desirable to make the most efficient use of these muscles when pedaling a bicycle, either in a race or simply in riding for pleasure, particularly over long distances. For serious bicycle racers improved efficiency can be very important to success.

Several factors other than the muscles contribute to the force actually applied to a bicycle's pedals. These include a centrifugal force from the circular motion of the pedal, an accelerative force due to the pumping action of the legs, and, not the least of which, is gravity. These additional forces complicate any analysis because they provide no net driving force and they can vary widely since two of them vary with the square of the pedal speed. Therefore, simply measuring pedal forces or torque is not a very good indicator of what the muscles are doing.

It is well-known that it is possible to provide force in a forward rotational direction throughout the entire rotation of a pedal, by the use of pedal clips or clipless pedals connecting a cyclist's feet to the pedal spindles and the proper coordination of the four muscle groups mentioned above.

It is well-known in the muscle work should be most efficient when contraction causes foot movement mostly parallel to the pedal movement. Conversely, muscles are least efficient when contraction would cause movement mostly perpendicular or contrary to the current pedal movement direction,

It is well-known that the four major muscle groups involved in pedaling a bicycle are of reasonably similar capability, so it is reasonable to assume that the most efficient pedaling action would be when the four muscle groups are all being used and used in a reasonably balanced fashion.

It is well-known that the power that determines how fast a bicycle will go is the average power produced by a cyclist throughout a complete rotation of the two pedal cranks, and cyclists can use that information to determine whether power developed during cycling is improving as a result of the cyclist's training efforts.

Despite ways to observe and measure pedal forces being available for about 50 years in the research community, no one has been able to come up with a simple method of separating out what the muscles are doing without using complex reverse engineering techniques applicable only to specific situations.

For many years strain gauges and computers have been used to measure total power on a bicycle. More recently these devices have been moved to the crank arm or pedal which allows the measurement of the power and pedaling technique of each individual leg. While this would seem to be a major improvement, no one has come up with a useful way to evaluate this data beyond measuring the power; hence all that is done is that the raw data is given to the user. A useful method of evaluating technique remains elusive.

The major reason for this is the data includes a lot of pedal forces that have nothing to do with the cyclist's muscles, so the real problem here is how to separate what the muscles are doing from everything else. While non-propulsive acceleration and centrifugal forces are also present these tend to balance each other. Accelerative forces are directed both up and down (from the pumping motion of the thigh and leg as it rotates back and forth around the hip) and forward and backward (as the lower leg pivots at the knee). From 0° to 90° the thigh is being accelerated downward, which reduces force on the pedal; from 90° to 180° the thigh is slowing down, which increases force on the pedal. Similar accelerations occur in the rear semicircle of pedal revolution. These accelerations are constantly changing in a sine wave pattern over each pedal revolution. The amplitude of the sine wave depends upon the mass of the legs, the rotational rate, and the length of the crank, but the accelerations always balance out to be a zero net propulsive force. The main confounding problem is gravity, as it is unidirectional. Because the legs are so massive gravity substantially increases the downward forces the pedal sees on the down stroke and decreases the upward forces the pedal sees on the upstroke (even though the muscles are doing substantial work). If one fails to account for gravity the raw data makes it look as though pedaling (as measured by muscle work performed) is much more unbalanced than it actually is. This failure of imagination has led the cycling community to conclude that pushing is the main component of power generation, and that little or no work is done on the upstroke, and that the upstroke is therefore unimportant,

For instance, data of actual pedal force vectors and crank torque at selected positions in a revolution of a pedal crank arm during cycling are readily available but impractical for everyday use. Torque varies widely around the pedaling circle and the measured torque is the result of a combination of forces from four different sources applied to the pedal and the crank length. Actual torque can be calculated by measuring the stress on a crank arm and multiplying by the radius at which the pedal is located. The sources of these four different forces are: 1. Centrifugal forces from the weight or the foot going around the circle; 2. Accelerative farces as the massive thigh and lower leg change direction up, down, backwards, or forward; 3. Gravity; and 4. Muscular forces. Force Components 1 and 2 vary with the mass of the rider, with the length of the crank, and with the square of the cadence. Force Component 3 varies with the mass of the rider. The net result of Force Components 1, 2, and 3 is zero net power output. The fourth component, muscular force actually applied to drive the pedal crank arm in the desired direction, is what one really wants to know, but the first three, extraneous Force Components make this almost impossible to know without knowing the specifics of each rider and performing some serious reverse engineering calculating. While such calculations have been done there are so many potentially error-causing factors that they are impractical.

As noted earlier, the ability to measure cycling pedal forces has been around in the laboratory setting for over 50 years. Recently, it has even been available to individuals riding their own bicycles. Many attempts have been made by scientists to correlate pedaling technique to cycling efficiency. In not a single instance has a single one of these scientists eliminated the gravity and other non-muscular components from their evaluations, and as a result measured cycling forces have never been shown to correlate with cycling efficiency, even though measured cycling gross efficiency (the ratio of energy transmitted to the road to the energy cost to the rider) has been shown to vary between 18% and 26%. This makes no engineering sense, and the explanation has to be that the nor-muscular confounding factors are muddying the analysis when using raw numbers, to the extent of making it useless. It would seem obvious that when evaluating efficiency one should only look at the muscular contributions.

Because cyclists vary in size and mass, and because the cyclist may be pulling up on one pedal while pushing down on the other, it is not a simple calculation to eliminate extraneous forces such as gravity from the measurement of torque applied through a pedal crank at any particular position of rotation.

The present disclosure provides a method to use the raw data to estimate muscle balance during pedaling (and, hence, relative efficiency of pedaling technique) on a simple numerical scale, with 1 being “perfect” and 0.9 probably being as good as anyone could hope to achieve.

One thought is that the most efficient way to pedal is to use a constant amount of muscular work around an entire rotation of the crank. This requires a balanced effort of the four major muscle groups mentioned above. When the pedal is moving up the muscles are doing work by increasing the potential energy of the leg even if no force is imparted to the pedal. This effort is returned to drive the bike on the downstroke, making it appear that the downward pushing muscles are doing more effective work than they really are. Because of the effects of gravity and the factors determined by the size and mass of the cyclist it is not easy to evaluate whether the cyclist's efforts are balanced between downward and upward pedal movement.

When the pedals are moving forward and backwards gravity has no influence on the driving force so analysis of imbalance is relatively easy in these two directions.

What is desired, then, based on the assumption that improved balance equals improved technique, is a way to determine how much imbalance there is between the driving forces applied to a crank arm through selected sectors of rotation of a pedal crank.

### SUMMARY OF THE INVENTION

The present disclosure, then, provides apparatus and a method for evaluating a cyclists pedaling muscle balance, in the expectation that this relates to pedaling efficiency and obtaining some insight into what changes in pedaling technique might improve the cyclist's performance.

Two fairly easily determined ratios are as follows: The first such ratio is the ratio of the power through the top half revolution of a pedal to either the average power through the whole revolution or to the bottom half revolution (inverted if the power across the top is more than the average or more than what is done across the bottom half revolution). The second such useful ratio is the ratio of the sum of the power seen at 090° and 270° twice the average power for the entire revolution at that time (inverted if it is more than 1). Finally, the product of those ratios is a simple number that estimates the degree of balance in the cyclist's pedaling, accounting for the confounding effect of gravity and ignoring the effects of centrifugal and accelerative forces.

According to one aspect of the present disclosure, the average torque applied (and thus the amount of work done at a steady speed) through one angular sector within a complete revolution of a pedal crank is compared with the average torque applied through another sector of rotation so as to determine how much imbalance there is between the average torques effectively applied in the two sectors.

According to another aspect of the present disclosure, a ratio of the two average torques may be revised by a chosen factor to result in a number falling within a prescribed scale that can be displayed.

According to one aspect of the present disclosure, a numerical value representing the amount of imbalance between the average torques applied in one pair of sectors of rotation may be multiplied by a numerical value representing an amount of imbalance between average torques applied in a different pair of sectors to result in a number that may be instructive to a cyclist.

An exemplary apparatus is disclosed by which the amount of imbalance between the cyclist's performance in selected sectors of a pedal revolution may be calculated and displayed in a useful and convenient manner.

The foregoing and other features and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a schematic representation of how measurements of torque applied through a pedal crank arm can be obtained and utilized.

FIG. 2 is a drawing showing representative vector forces on the pedal being driven by a cyclist.

FIG. 3 is a schematic diagram illustrating some sectors of rotation of a crank through which torque measurements may be averaged for use according to the method disclosed herein.

FIG. 4 is a graph showing plots of power values in Cartesian coordinates through a complete rotation of a crank arm for each of two cyclists,

FIG. 5 is a representation in polar coordinates showing power values for a cyclist through a complete rotation of each of a pair of crank arms.

FIG. 6 is a representation in polar coordinates showing power values for a different cyclist through a complete rotation of each of a pair of crank arms.

FIG. 7 is a flow chart showing steps in performing the method disclosed herein for analyzing pedaling efficiency.

### DETAILED DESCRIPTION OF PREFERRED EMBODIMENTS

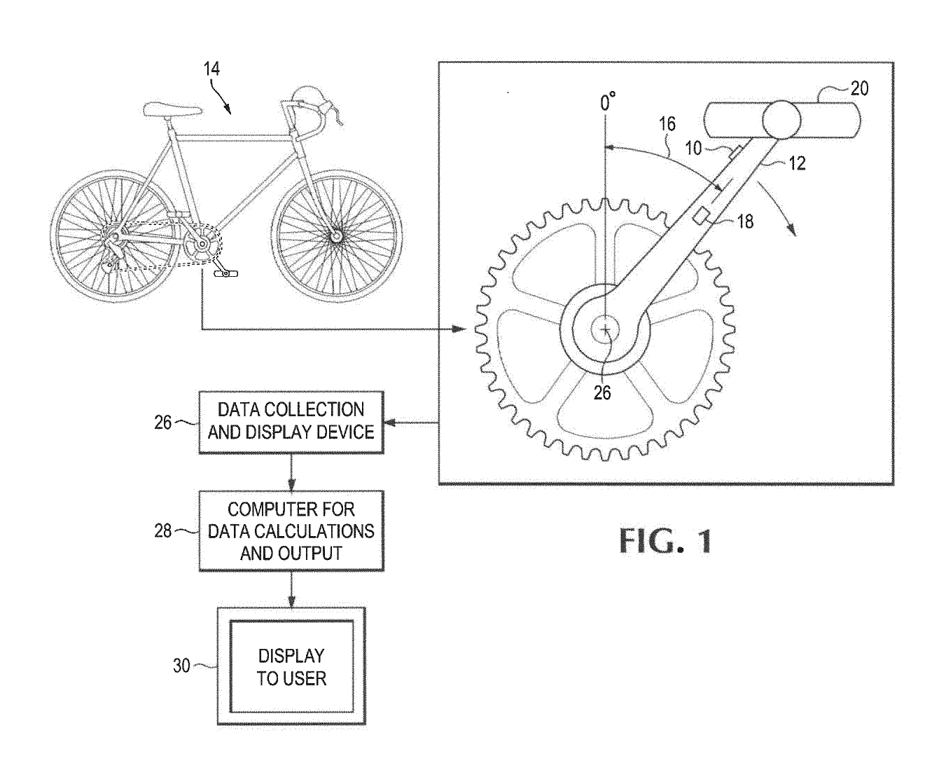

Referring now to the drawings which form a part of the disclosure herein, in FIG. 1 an exemplary arrangement is shown schematically, wherein data regarding the torque instantaneously being applied to a pedal crank arm by a cyclist may be recorded and correlated with the angular position of the crank arm for each torque measurement. A strain gauge 10 (or other device used to measure force on a pedal) may be mounted on a crank arm 12 of a bicycle 14 and may be capable of providing an electrical signal at frequent precisely determined times, indicating the amount of stress being applied to the pedal crank arm at each time, as shown in FIG. 1.

The position angle 16 of the pedal crank arm at the time when each torque measurement is made can be determined in well-known ways. For example, it may be assumed that the rotational speed of the crank is effectively constant and crank arm position may be calculated by observing the time when the crank arm 12 is at a predetermined position such as being vertical, at the 0° position, by the use of a device such as a Hall effect transducer mounted on the bicycle frame. Or, the crank arm may include a position sensor 18 as typically found in cell phones or gaming controllers, allowing the actual crank arm position to be correlated directly and contemporaneously to a particular torque measurement.

The method disclosed herein allows one to compare data in a way in which the confounding effects of gravity (and some of the forces due to acceleration) are reduced or eliminated, allowing one to come up with a useful method of estimating muscular balance (or imbalance) while pedaling a bicycle. The many ways that this can be accomplished range from the very simple to quite complex. The most important aspect of the method disclosed herein is to minimize or eliminate the confounding effects of gravity in a way that is appropriate for the circumstances (a laboratory setting may use a more complex calculation than is practical for a display while riding a bicycle). When the effects of gravity are removed from the data the data then becomes much more useful.

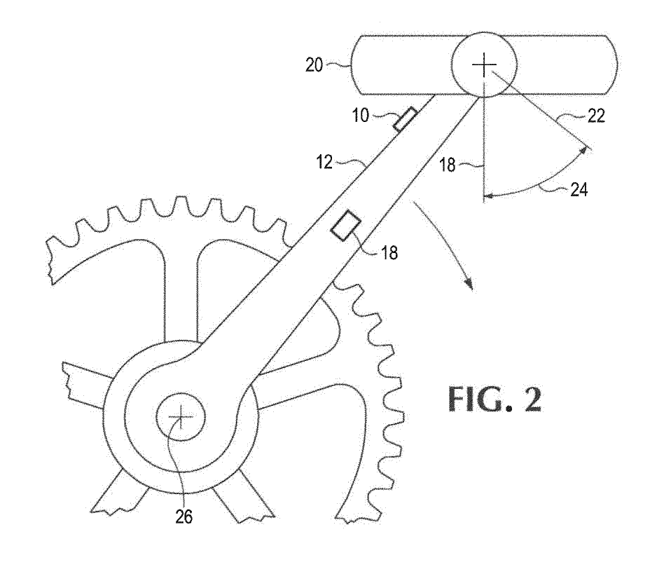

As shown in FIG. 2 the downward force 18 of a cyclist's weight on a pedal 20 resolves into a crank driving force 22 in a direction tangent to the pedal circle of revolution, and a radial component 24 toward the crank axis of rotation 26.

Gravity always operates in the vertical direction. The simplest manifestation of the present method of evaluating efficiency, then, is to divide the pedaling circle on a horizontal plane and compare the top half to the bottom half or the top half to the average for the whole circle. Gravity components of the torque on the crank arm are equal between the downward and upward segments, and so gravity cannot affect the result. Experience has also shown that the weakest part of “everyone's” stroke is coming across the top, so it would be expected this would be fairly sensitive even though quite simple.

As shown in FIG. 1, data can be collected and displayed and recorded in a data collection device 26 and manipulated as desired in a calculation unit 28, which may be a suitably programmed computer, and the results can be presented contemporaneously or periodically, as desired, by a display device 30.

A more sensitive method of assessing balance would be to increase the number of angular sectors being compared, but then it would not be so easy to balance out the gravity component. For example, dividing into quadrants is one possibility.

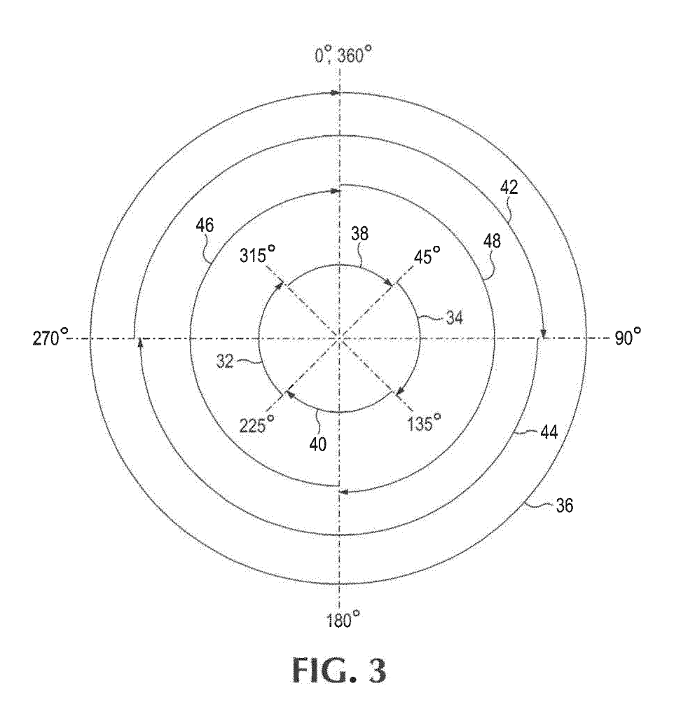

That is, one way to calculate a gravity-compensated number representative of muscular performance is to divide the circle of pedal revolution into forward, down, back, and up quadrants, that is, the quadrants between 315°, 45°, 135°, and 225° positions 16 of a crank arm 12, as shown in FIG. 3. The up (32) and down (34) (rear and front) quadrants are where the crank arm 12 is moving in opposite vertical directions, so if the amounts of torque applied to, (or work done on) the crank arm in both of those quadrants 32 and 34 are added together the gravity component cancels out. This sum can then be compared to what would be expected if both quadrants 32 and 34 were at the average for the entire revolution 36 as by expressing a ratio of the two values, to get an initial balance ratio (inverted if necessary to always be less than 1) which is then multiplied by the top/bottom ratio for a final number.

What the method disclosed herein does in one embodiment is evaluate muscular balance through those four quadrants of the pedal stroke (up (32), forward (38), down (34), and backwards (40)) without knowing or needing to know anything about the size or mass of the rider, the pedaling cadence, or the crank length. Fairly simple calculation using the available correlated torque and crank arm position data gives the rider a number reflecting how balanced his or her pedaling stroke is, and that number can then be used as a basis for measuring improvement in this important metric. This is so simple it can be done in real time similar to what is done currently in bicycle power meters that give the average of the widely varying instantaneous power/torque seen around the pedaling circle.

There are numerous methods by which the numbers can be manipulated, and the best method for different purposes will be discovered with time and experimentation. The one factor common to all the ways to evaluate the data is the need to minimize or eliminate the confounding effects of gravity on the raw data. Using the presumption that the best pedal stroke is a balanced pedal stroke (there is scientific data to support such a presumption) the closer the resultant ratio is to 1 the mare balanced the work performed by the muscles would be. Novice riders may have imbalance ratios in the 0.5 to 0.6 range whereas elite and very efficient cyclists might be at 0.9 or above. If substantial imbalance were measured the athlete would know this would be a promising area to work on to improve performance. The method disclosed herein for analyzing the available data can turn very complex or voluminous data into a single, simple, reproducible, and usable resulting number.

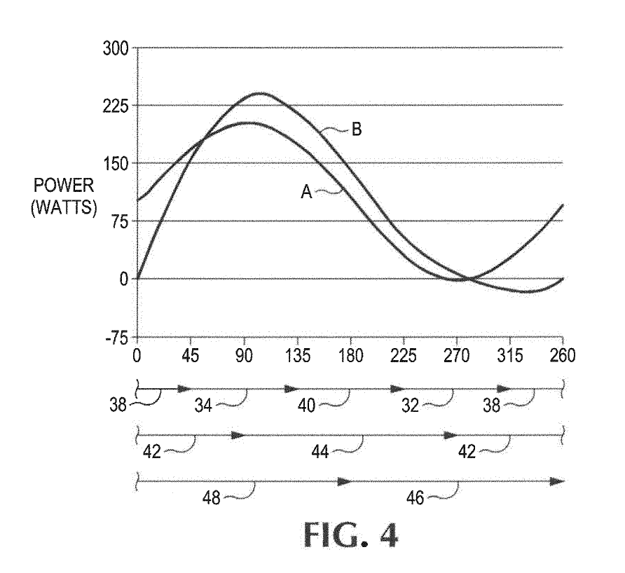

If a cyclist is generating 200 watts and is equally balanced between the right leg and the left leg that means the cyclist is generating 100 watts with each leg. The curves shown in FIG. 4 compare a typical pedaling technique illustrated by curve B to a perfectly balanced technique, that is, a power distribution that follows a sine wave, as illustrated in curve A. The average power is the area under the curves, and both of these curves show 100 watts with the curve A being “perfect balance” and the curve B being the pattern typically seen in cyclists.

Using the available data, three simple computations produce numbers that can make it easy for the cyclist to understand where his technique could be improved without need for knowing a single data point or what this curve looks like.

A first useful number is Top-to-Bottom balance. This is simply the ratio of the average power generated from 270° to 90° in the pedal crank arm revolution, divided by the average power generated from 90° to 270°, when top dead center represents 0°. In other words, the power generated in the top half 42 of the pedal crank arm revolution, divided by the power generated in the bottom half 44 of the pedal revolution. Top-to-Bottom balance for curve A is 1 and for curve B is 0.684. This could also be called “Knee Balance,” as the knee extensors and knee flexors are the primary sources of the forward and rearward forces on the pedals. To isolate the knee balance even more the ratio could be based on the average power in the 315° to 045° sector 38 and the 135° to 225° sector 40 shown in FIG. 3.

A second useful number is the Front-to-Rear balance, the ratio of the power generated on the upstroke half revolution 46 of the crank arm to the power generated on the downstroke half revolution 48. This could be called “Hip Balance,” as the hip extensors and hip flexors are the primary sources of the downward and upward forces exerted on the pedals. To isolate the hip forces more the Hip Balance ratio could be computed on the basis of the average power in sector 34, from 045° to 135° and sector 32, from 225° to 315°, shown in FIG. 3.

In FIG. 4 the Front-to-Rear balance number is again 1 for curve A, and is 0.876 for curve B.

The final calculation would be the overall balance. This number is obtained simply by multiplying the Top-to-Bottom balance by the Front-to-Rear balance. In the example depicted in FIG. 4 and described briefly above, the overall balance for curve A is 1 and for curve B is 0.599.

From these three numbers we can easily understand that the balance for curve A is perfect, but the pedaling represented by curve B is quite unbalanced. While curve B shows imbalance both in the horizontal and vertical directions, the major area of imbalance is in the Top-to-Bottom balance or “Knee Balance,” so more improvement can be expected working on correcting that than by working on the Front-to-Rear or “hip” imbalance. These numbers do not reflect how much improvement of efficiency is possible but do provide a reflection of the relative imbalances that exist in the pedal stroke, with the presumption that better balance is more efficient.

The above is not the only method of doing such a balance analysis but only an example of the potential.

To describe the same data in a slightly different manner, Top/Bottom is the ratio of the average power in the sector that is the top half of a complete revolution of a crank arm to the average power in the sector that is the bottom half of a complete revolution of the crank arm. The Top/Bottom ratio will typically vary from 0.33 to 0.85.

Top/Avg balance is the ratio of the average power in the sector that is the top half of the complete revolution of a crank arm to the average power for the complete revolution. The Top/Avg ratio will typically vary from 0.5 to 0.93.

“H squeeze” is the ratio of the sum of the power at 90° and the power at 270°, divided by two times the average power for a complete revolution (“H squeeze” will always be less than one). The “H squeeze” ratio will typically vary from 0.72 to 0.90.

T/Avg-HS is the product of the Top/Avg number and the “H squeeze” number. The result is a number that typically will vary from 0.36 to 0.90 and ideally, with perfectly balanced pedaling, would be 1.

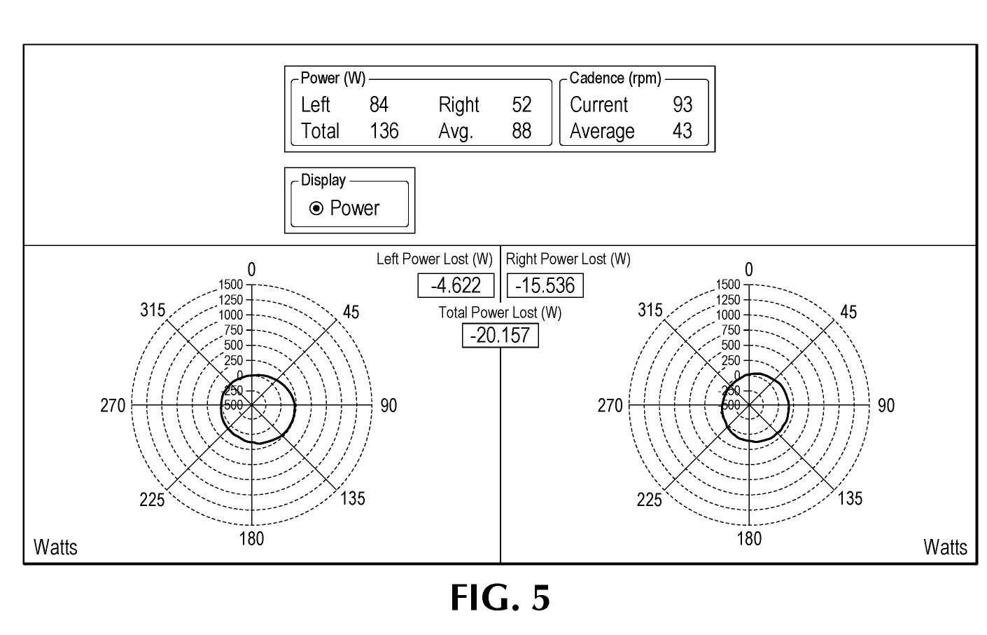

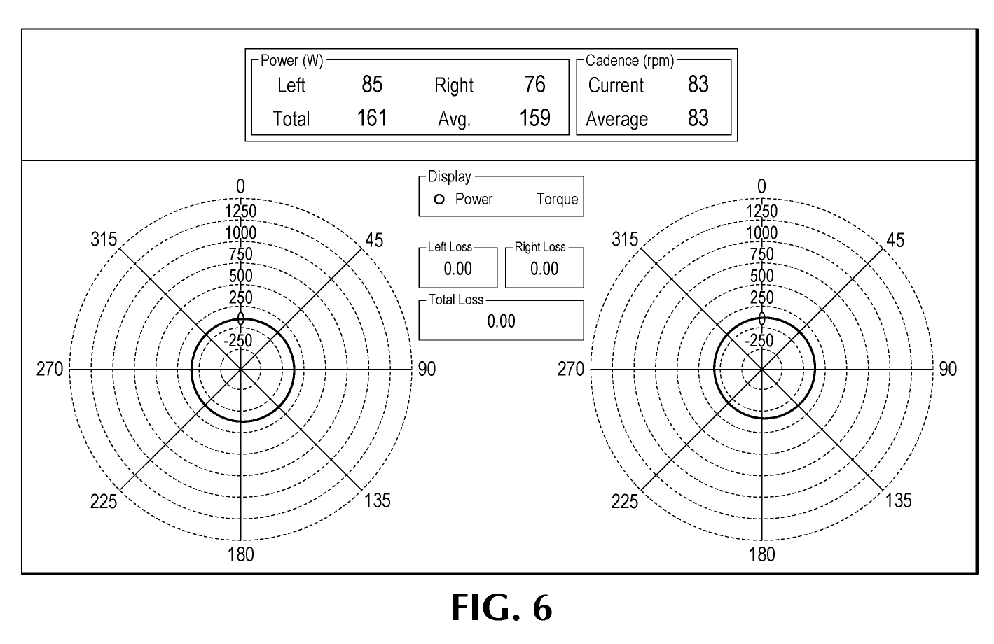

FIGS. 5 and 6 show plots of pedaling performance by different cyclists, showing power applied to each of the left and right crank arms separately in polar coordinates, where the angles shown are based on crank arm revolutions with 0° being the top of a crank revolution. In FIG. 5, with careful observation of the plots it can be seen that more power is delivered to each crank arm in the front half revolution and little or no power is delivered in the rear half revolution. Also, more power is delivered in the bottom half revolution, between 90° and 270°, than in the top half revolution, between 270° and 90°, and that in the top rear quadrant, between 270° and 0° the cyclist is even impeding the crank arm's revolution.

In FIG. 6, in contrast, the cyclist is providing power to each crank arm through the entire revolution of each pedal. While it can be seen by close examination that there is some imbalance between the amounts of power delivered in different sectors of each crank arm's revolution the cyclist is pedaling in a more balanced manner, which indicates a more efficient pedaling technique.

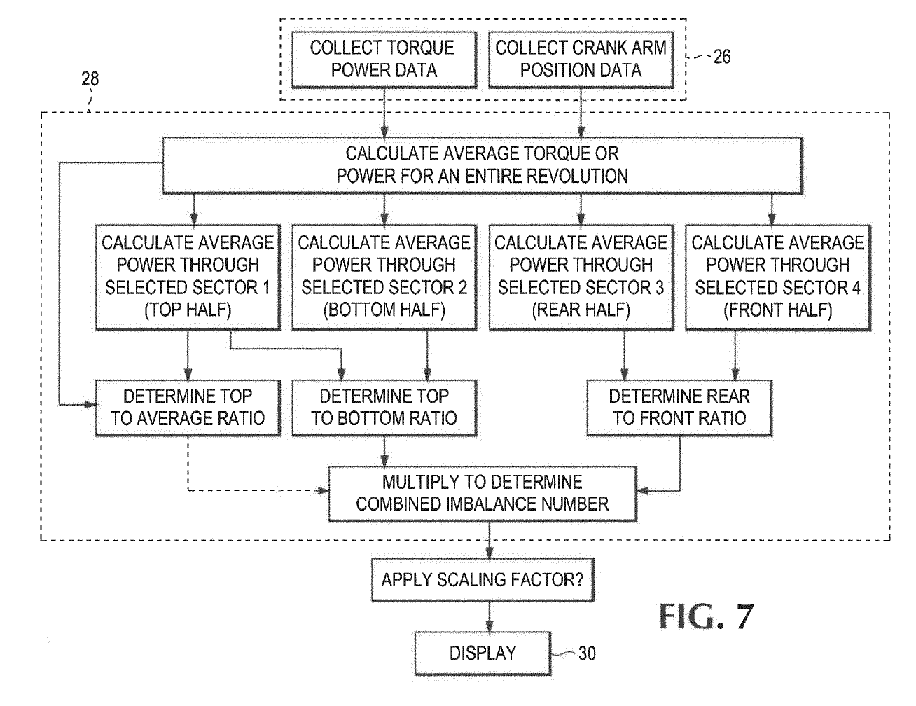

In FIG. 7 the steps of performing the method disclosed herein are shown in flowchart form with torque or power and position data being collected by the device 26 shown in FIG. 1, various calculations and output steps being performed by a suitably programmed computer 28 performing the steps mentioned above of calculating average power, average torque, or power for an entire revolution, and for selected sectors of an entire revolution of a crank arm and then comparing those averages in a selected manner such as by determining the various ratios mentioned previously and, if desired, manipulating selected ones of those ratios also as discussed above.

While the resulting ratios were mentioned above as absolute numerical results in a range from 0 to 1, it may be desired to apply a scaling factor and provide the resulting number in a display on a desired different scale.

Before beginning to evaluate a cyclist's performance, it may be useful to obtain a set of data for use as a calibration or baseline evaluation of the cyclist's pedaling efficiency. As mentioned above, there are several factors that affect the actual force sensed by a pedal crank arm and that are different depending upon a particular cyclist's size and build. A set of calibration data can be obtained by measuring the forces seen by the crank arms while the cyclist is pedaling at a very low effort at each of a variety of, at least three, cadences. If the total power is the same for the three data sets, then the differences in pedal forces seen can be assumed to be due to changes in the non-muscular components. While gravity is constant the two accelerative forces will vary with the square of the cadence. Hence we have three data sets and three unknowns, so it is relatively simple to calculate what the non-muscular forces should be at any given cadence for the rider doing the calibration. Once this is known then the non-muscular forces can be subtracted from the raw data and a reasonable representation of the actual muscle forces is available, and the balance can be calculated directly.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A method for evaluating pedaling efficiency of a cyclist, comprising:
(a) collecting crank torque and position data at a plurality of crank arm positions during a complete revolution of a crank arm while the cyclist is pedaling;
(b) from the collected crank torque and position data computing a first average torque produced through a top half of a pedal crank arm revolution;
(c) from the collected crank torque and position data computing a second average torque produced through a bottom half of the pedal crank arm revolution; and
(d) comparing the first average torque to the second average torque and thus deriving a resulting number representative of the difference between the first and second average torques.

2. The method of claim 1 wherein the resulting number is the arithmetical difference between the first and second average torques.

3. The method of claim 1 wherein the resulting number is the ratio of the second average torque to the first average torque.

4. The method of claim 1 wherein the step of collecting crank torque and position data is performed using electronic sensors and transmitting each torque and crank arm position data element to a digital computer, and wherein the method includes the step of using the digital computer for computing and comparing the first and second average torques.

5. The method of claim 1 including the further steps of:
(a) computing a third average torque produced during a forward half of a pedal crank revolution;
(b) computing a fourth average torque produced during a rearward half of a pedal revolution;
(c) comparing the third average torque to the fourth average torque so as to derive a resulting number representative of the difference between the first and second average torques; and wherein
(d) the number representative of the difference between the first and second average torques is a ratio of the values of the first and second average torques and wherein the number representative of the difference between the third and fourth average torques is a ratio of the values of the third and fourth average torques; and
(e) including the further step of multiplying the ratio of the values of the first and second average torques by the ratio of the values of the third and fourth average torques, thereby computing a number representative of the degree to which the cyclist is pedaling in a balanced manner.

6. A method of observing changes of pedaling techniques of a cyclist comprising:
performing the method of claim 1;
thereafter performing the method of claim 1 at another time; and
comparing the resulting numbers so as to evaluate improvement or decrement.

7. A method of observing changes of pedaling techniques of a cyclist comprising:
performing the method of claim 5;
thereafter performing the method of claim 5 at another time; and
comparing the resulting numbers so as to evaluate improvement or decrement.

8. The method of claim 7 wherein the resulting number is the arithmetical difference between the first and second average torques.

9. The method of claim 7 wherein the resulting number is the ratio of the second average torque to the first average torque.

10. The method of claim 7 wherein the step of collecting crank torque and position data is performed using electronic sensors and transmitting each torque and crank arm position data element to a digital computer, and wherein the method includes the step of using the digital computer for computing and comparing the first and second average torques.

11. The method of claim 7 including the further steps of:
(a) computing a third average torque produced during a forward half of a pedal crank revolution;
(b) computing a fourth average torque produced during a rearward half of a pedal revolution;
(c) comparing the third average torque to the fourth average torque so as to derive a resulting number representative of the difference between the first and second average torques; and wherein
(d) the number representative of the difference between the first and second average torques is a ratio of the values of the first and second average torques and wherein the number representative of the difference between the third and fourth average torques is a ratio of the values of the third and fourth average torques; and
(e) including the further step of multiplying the ratio of the values of the first and second average torques by the ratio of the values of the third and fourth average torques, thereby computing a number representative of the degree to which the cyclist is pedaling in a balanced manner.

12. A method for evaluating relative pedaling efficiency, comprising:
(a) obtaining crank torque and position data while pedaling;
(b) determining a first average torque through a first predetermined sector of a crank rotation;
(c) determining a second average torque through a second predetermined sector of a crank rotation, the second predetermined sector being opposite and of equal angular size to the first predetermined sector;
(d) modifying the first average torque by a factor that accounts for the non-muscular forces in the measured average torque, especially gravity;
(e) modifying the second average torque by a factor that accounts for the non-muscular Forces in the measured average torque, especially gravity;
(f) comparing the first modified average torque to the second modified average torque.

13. The method of claim 12 including repeating steps (b)-(f) for additional pairs of predetermined sectors until the average torques have been compared for predetermined sectors comprising the entire crank rotation, and combining these comparisons in a manner that reflects an overall score for pedaling balance around the circle.
